(19) United States
(12) Patent Application Publication
(10) Pub. No.: US 2024/0190139 A1
(43) Pub. Date: Jun. 13, 2024

(54) PRINTING SYSTEM AND PRINTING METHOD WITH INTELLIGENT COLOR-MATCHING

(71) Applicant: INDUSTRIAL TECHNOLOGY RESEARCH INSTITUTE, Hsinchu (TW)

(72) Inventors: Hsi-Kang SHIH, New Taipei City (TW); Wesley Jen-Yang CHANG, Tainan City (TW); Mei-Wen HSU, Xinfeng Township (TW); Wen-Pin CHUANG, Hsinchu City (TW); Shinn-Jen CHANG, Hsinchu City (TW)

(73) Assignee: INDUSTRIAL TECHNOLOGY RESEARCH INSTITUTE, Hsinchu (TW)

(21) Appl. No.: 18/533,840

(22) Filed: Dec. 8, 2023

Related U.S. Application Data
(60) Provisional application No. 63/431,494, filed on Dec. 9, 2022.

(30) Foreign Application Priority Data
Nov. 17, 2023 (TW) 112144431

(51) Int. Cl. B41J 2/21; B41J 2/525; C09D 11/38; G06N 20/00

(52) U.S. Cl. CPC B41J 2/2107; B41J 2/525; C09D 11/38; G06N 20/00

(57) ABSTRACT

Provided is a printing system with intelligent color-matching, including a storage device, a printing device, and a processing device. The storage device stores a program, a color-matching dataset, and a color-matching model. The color-matching dataset contains multiple pieces of color-matching data, and each piece of color-matching data includes an ink formula and a corresponding printing color value for the ink formula. The printing device is controlled to produce printed products. The processing device loads the program from the storage device to perform the following tasks: training the color-matching model using the color-matching dataset; inputting the expected color value into the trained color-matching model, and obtaining a predicted formula output by the trained color-matching model; and based on the predicted formula, controlling the printing device to produce the printed product.

### CROSS REFERENCE TO RELATED APPLICATIONS

This application claims the benefit of U.S. Provisional Application No. 63/431,494, filed Dec. 9, 2022, the entirety of which is incorporated by reference herein.

This Application claims priority of Taiwan Patent Application No. 112144431, filed on Nov. 17, 2023, the entirety of which is incorporated by reference herein.

### BACKGROUND

### Technical Field

The present disclosure relates to color printing technology, and, in particular, to a printing system and printing method with intelligent color-matching.

### Description of the Related Art

A printing press is a mechanical device for printing text and/or images on a substrate. Due to the unique color effects of each substrate, even with the same ink formula, the printed products on different substrates may exhibit color variations. Additionally, in the context of digital printing, the principles of image formation differ between computer displays and printing presses. Computer displays typically use RGB color light imaging, while printing presses usually use CMYK four-color inks for printing. These factors may result in discrepancies between the color of the printed product and the customer's expectations, necessitating the expertise of specialized personnel for color formulation and adjustment. However, manual color matching still faces several unresolved issues. For example, in R2R (Roll-to-Roll) printing, despite its advantages of large area, fast continuous printing, and low cost, color matching and adjustment rely on manual comparisons. This leads to prolonged ink formula times, excessive ink material consumption, and poor control over the color values of printed products, hindering quality management.

With the trend of the manufacturing industry moving towards automation and digital production, there is a need for an intelligent color-matching solution to enhance the efficiency and batch stability of printing systems.

### BRIEF SUMMARY

An embodiment of the present disclosure provides a printing system with intelligent color-matching, including a storage device, a printing device, and a processing device. The storage device stores a program, a color-matching dataset, and a color-matching model. The color-matching dataset contains multiple pieces of color-matching data, and each piece of color-matching data includes an ink formula and a corresponding printing color value for the ink formula. The printing device is controlled to produce printed products. The processing device loads the program from the storage device to perform the following steps. The processing device trains the color-matching model using the color-matching dataset. The processing device inputs the expected color value into the trained color-matching model, and obtains the predicted formula output by the trained color-matching model. Based on the predicted formula, the processing device controls the printing device to produce the printed product.

In addition, an embodiment of the present disclosure provides a printing method with intelligent color-matching. The printing method is executed by a processing device. The printing method includes the step of training the color-matching model using the color-matching dataset. The printing method further includes the step of inputting the expected color value into the trained color-matching model, and obtaining a predicted formula output by the trained color-matching model. The printing method further includes the step of controlling, based on the predicted formula, the printing device to produce a printed product.

### BRIEF DESCRIPTION OF THE DRAWINGS

The present disclosure can be more fully understood by reading the subsequent detailed description and examples with references made to the accompanying drawings, wherein:

FIG. 1 is a system block diagram of a printing system with intelligent color-matching, according to an embodiment of the present disclosure;

FIG. 2A is a flow diagram of a printing method with intelligent color-matching, according to an embodiment of the present disclosure; and

FIG. 2B is a schematic diagram of a printing method with intelligent color-matching, according to an embodiment of the present disclosure.

### DETAILED DESCRIPTION

The following description is made for the purpose of illustrating the general principles of the disclosure and should not be taken in a limiting sense. The scope of the disclosure is best determined by reference to the appended claims.

In each of the following embodiments, the same reference numbers represent identical or similar elements or components.

It must be understood that the terms “including” and “comprising” are used in the specification to indicate the existence of specific technical features, numerical values, method steps, process operations, elements and/or components, but do not exclude additional technical features, numerical values, method steps, process operations, elements, components, or any combination of the above.

Ordinal terms used in the claims, such as “first,” “second,” “third,” etc., are only for convenience of explanation, and do not imply any precedence relation between one another.

The description of embodiments for devices or systems is also applicable to embodiments of methods, and vice versa.

Embodiments of the present disclosure adopt a machine learning approach, where a color-matching dataset is built through the collection and cleaning of ink formulas and color data. This dataset is then used to train a color-matching model. The trained color-matching model can be used to predict the ideal color ink formula, which can subsequently be used to produce printed products based on the predicted formula. In further embodiments, a novel surface tension-adjusting additive is introduced into the ink formula to enhance the convergence and accuracy of the color-matching model, as well as to improve printing resolution and color uniformity.

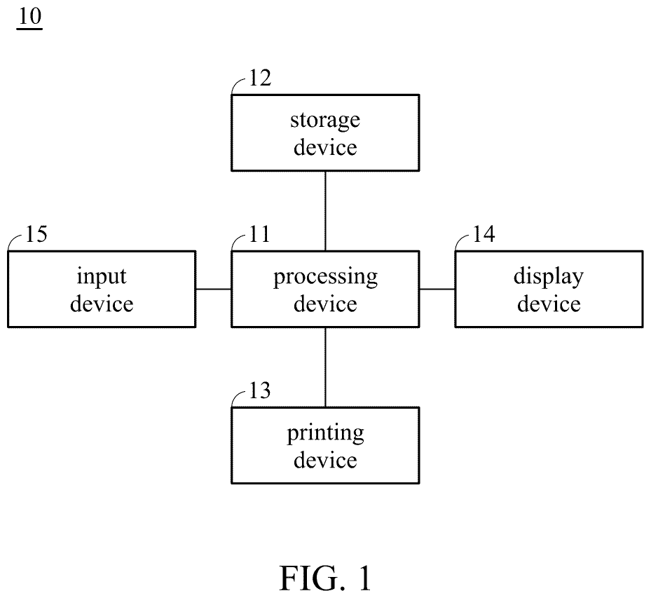

FIG. 1 is a system block diagram of a printing system 10 with intelligent color-matching, according to an embodiment of the present disclosure. As shown in FIG. 1, the printing system 10 includes a processing device 11, a storage device 12, and a printing device 13.

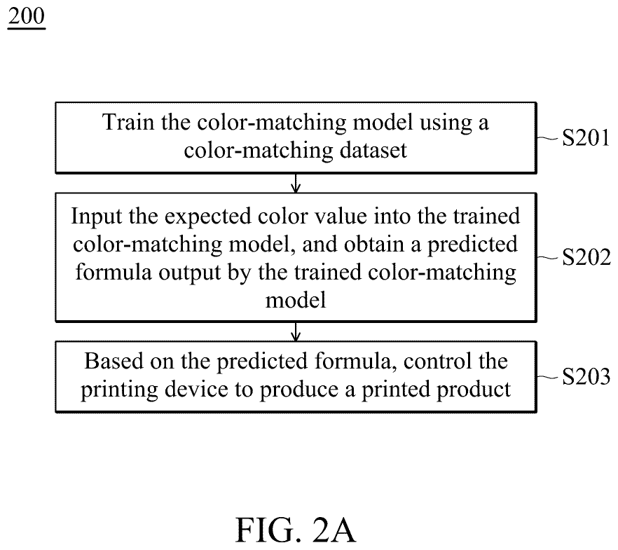

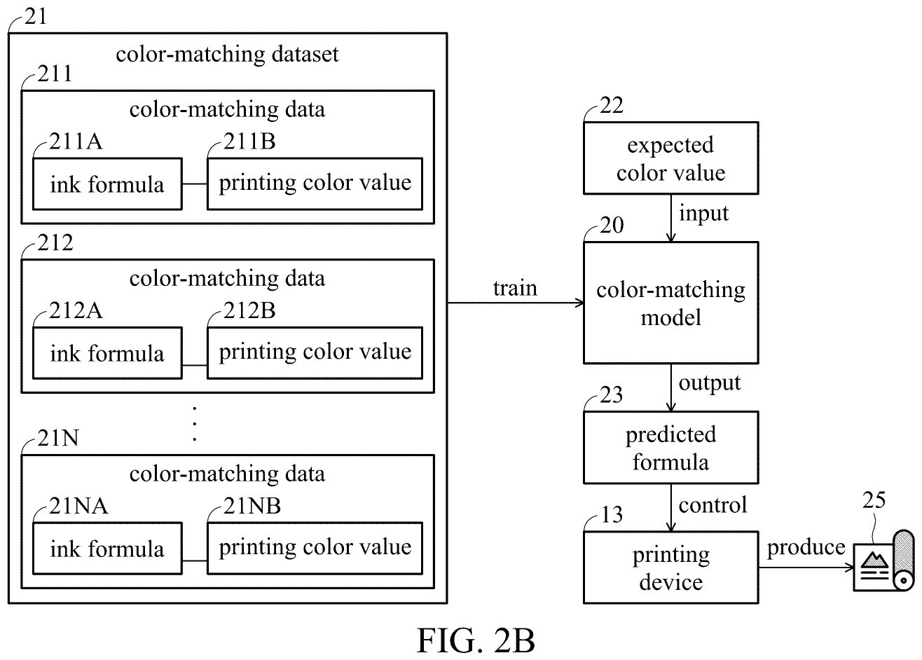

The processing device 11 may include one or more hardware components for executing instructions, such as a central processing unit (CPU), graphics processing unit (GPU), microprocessor, controller, microcontroller, Application Specific Integrated Circuit (ASIC), Field Programmable Gate Array (FPGA), System on a Chip (SoC), etc., but the present disclosure is not limited thereto. The processing device 11 loads the program from the storage device 12 to execute a printing method with intelligent color-matching. The details of this printing method will be described in more detail with reference to FIGS. 2A and 2B. In an embodiment, these hardware components can be deployed locally (i.e., at the on-site end where the printing device 13 producing the printed product is located) to perform all steps of the printing method. In another embodiment, these hardware components can be deployed separately at the remote and on-site ends, performing the steps of training the color-matching model and predicting the ink formula using the color-matching model, respectively.

The storage device 12 can be any device with non-volatile memory (e.g., read-only memory (ROM), electrically-erasable programmable read-only memory (EEPROM), flash memory, non-volatile random access memory (NVRAM)), such as hard disk drive (HDD) arrays, solid-state drives (SSD), or optical discs, but the present disclosure is not limited thereto. The storage device 12 can be fully or partially deployed locally (i.e., at the on-site end where the printing device 13 producing the printed product is located) or remotely, but the present disclosure is not limited thereto. In the embodiments of the present disclosure, the storage device 12 stores a program containing multiple instructions for implementing the printing method described above. When the processing device 11 loads this program from the storage device 12, these instructions will be executed to implement the printing method. In addition, the storage device 12 also stores the color-matching dataset and color-matching model, which will be described in more detail with reference to FIG. 2B.

The printing device 13 can be any color printer used to print text and/or images on a substrate. The substrate can be various types of paper (e.g., newsprint, coated paper, gravure paper, map paper, poster paper, etc.), various fiber fabrics (e.g., clothing, scarves, ties, bed sheets, bedspreads, pillowcases, etc.), various plastic rolls (e.g., films, sheets, synthetic leather, wallpaper, etc.), ceramics, metals, etc., but the present disclosure is not limited thereto. The ink of the printing device 13 is typically prepared in the CMYK four-color mode (although the present disclosure is not limited thereto), where C represents cyan, M represents magenta, Y represents yellow, and K represents black. In the embodiments of the present disclosure, the printing device 13 is connected to the processing device 11 in a wired or wireless manner and is controlled by the processing device 11 to produce printed products.

In an embodiment, the printing system 10 further includes a display device 14 and an input device 15. The display device 14 can be any type of display, such as an LCD display, LED display, OLED display, electronic paper, projector, or plasma display, but the present disclosure is not limited thereto. The input device 15 may include, for example, a mouse, keyboard, control panel, touch display component, voice input device, or keypad, but the present disclosure is not limited thereto. In this embodiment, the display device 14 can present the predicted formula from the color-matching model to the user (e.g., a color-matching specialist or colorist), and the printing system 10 allows the user to fine-tune the predicted formula through the input device 15. Additionally, the printing system 10 allows the user to input the expected color values of the printed product through the input device 15.

In an embodiment, the printing system 10 may further include a communication interface (not shown in FIG. 1), which allows the printing system 10 to communicate with other devices to obtain and/or update data required for implementing the intelligent color-matching printing method described above, such as the aforementioned program, color dataset, and color-matching model. The communication interface can be a wired communication interface, such as High Definition Multimedia Interface (HDMI), DisplayPort (DP) interface, embedded DisplayPort (eDP) interface, Universal Serial Bus (USB) interface, USB Type-C interface, Thunderbolt interface, Digital Video Interface (DVI), and combinations thereof. It can also be a wireless communication interface, such as 5th Generation (5G) wireless system, Bluetooth, Wi-Fi, Near Field Communication (NFC) interface, etc., but the present disclosure is not limited thereto.

FIG. 2A is a flow diagram of a printing method 200 with intelligent color-matching, according to an embodiment of the present disclosure. As shown in FIG. 2A, the printing method 200 includes steps S201-S203. Correspondingly, FIG. 2B is a schematic diagram of the printing method 200. Please refer to both FIG. 2A and FIG. 2B for a clearer understanding of the embodiments of the present disclosure.

The printing method 200 can be executed by the processing device 11 in FIG. 1. In step S201, the color-matching model 20 is trained using the color-matching dataset 21. Then, the method 200 proceeds to step S202.

In step S202, the expected color values 22 is input into the trained color-matching model 20, and the predicted formula 23 output by the trained color-matching model 20 is obtained. Then, the method 200 proceeds to step S203.

In step S203, the printing device 13 is controlled to produce the printed product 25 based on the predicted formula 23.

As shown in FIG. 2B, the color-matching data set 21 includes multiple pieces of color-matching data 211-21N. Each piece of color-matching data includes an ink formula and its corresponding printing color value. For example, color-matching data 211 includes ink formula 211A and its corresponding printing color value 211B, color-matching data 212 includes ink formula 212A and its corresponding printing color value 212B, color-matching data 21N includes ink formula 21NA and its corresponding printing color value 21NB . . . and so forth. In other words, color-matching data 211 is associated with the mapping between ink formula 211A and printing color value 211B, color-matching data 212 is associated with the mapping between ink formula 212A and printing color value 212B, color-matching data 21N is associated with the mapping between ink formula 21NA and printing color value 21NB . . . and so forth.

In an embodiment, the color-matching data 211-21N in the color-matching data set 21 can be collected through printing experiments on specific substrates. Different substrates may have their corresponding color-matching data sets 21.

In an embodiment, the printing color values 211-21N are obtained through measurements using a colorimeter from the printed products produced by the printing device 13 with the corresponding ink formulas 211A-21NA. The printing color values 211-21N are typically defined in the CIELAB color space (also referred to as “CIE Lab*”), where L* represents brightness, a* represents green-red chromaticity, and b* represents green-yellow chromaticity, although the present disclosure is not limited thereto.

In an embodiment, the color-matching model 20 is a regression model with the dependent variable being the printing color values and the independent variable being the ink formula. In this embodiment, during the model training process (i.e., step S201), loss functions such as mean square error (MSE), mean absolute error (MAE), mean squared logarithmic error (MSLE), root mean square error (RMSE), mean absolute percentage error (MAPE), standard deviation (a), normalized mean square error, absolute error, relative error, and other loss functions can be used to calculate the loss representing the difference between the predicted formula output by the regression model and the actual printing color values. For example, by inputting the ink formula 211A into the regression model to obtain the first predicted formula (not shown in FIG. 2B), the first loss value represents the difference between the first predicted formula and the printing color value 211B. Similarly, by inputting the ink formula 212A into the regression model to obtain the second predicted formula (not shown in FIG. 2B), the second loss value represents the difference between the second predicted formula and the printing color value 212B, and so on. Furthermore, an optimizer can be used to iteratively adjust the parameters of the regression model to minimize the loss value and optimize the regression model. Optimizers can be implemented using algorithms such as gradient descent (GD), batch gradient descent (BGD), stochastic gradient descent (SGD), mini-batch gradient descent (MBGD), momentum, Nesterov accelerated gradient, AdaGrad, RMSprop, AdaDelta, or adaptive moment estimation (Adam), but the present disclosure is not limited thereto. For example, using the gradient descent optimizer, the parameters of the regression model are adjusted based on the gradient obtained by calculating the partial derivative of the loss function, thereby reducing the loss value. Through iterative feedback and parameter updates, the loss value is gradually reduced until it converges to a minimum value.

In an embodiment, the color-matching model 20 is selected based on the training error and testing error of various regression models. The selection is made from multiple regression models, such as linear regression, neural networks, decision tree, and random forest. The training results of these regression models are shown in <Table 1>, where RMSE values are used as training and testing errors.

TABLE 1

| Regression Model | Training RMSE | Test RMSE |
|---|---|---|
| Linear Regression | 0.833 | 0.670 |
| Neural Networks | 0.838 | 0.668 |
| Decision Tree | 0.000 | 1.019 |
| Random Forest | 0.349 | 0.999 |

The information from Table 1 indicates that the linear regression model and the neural network regression model have high training errors (both above 0.5), suggesting underfitting. The decision tree regression model shows a significant gap between training error (0.000) and testing error (1.019), indicating overfitting. Both underfitting and overfitting regression models have poorer predictive capabilities. Therefore, in this embodiment, the random forest regression model is selected as the color-matching model 20.

In an embodiment, the ink formulas 211B-21NB and the predicted formula 23 are each associated with a composition of various chemical materials, wherein one of the chemical materials is a surface tension-adjustment additive. In other words, the ink formulas 211B-21NB and the predicted formulas 23 contain components of surface tension-adjustment additives, and the dependent variable of the color-matching model 20 includes the content of surface tension-adjustment additives. The introduction of surface tension-adjustment additives can enhance print resolution, as well as the stability and uniformity of colors.

In a further embodiment, the surface tension-adjustment additive mentioned above has a spherical polyester structure. The outer periphery of this polyester structure has hydroxyl groups, and there are multiple alkyl chains forming the extending chains. The spherical polyester structure can also be a symmetrical structure. This polyester structure can further enhance surface tension, preventing ink on the substrate from collapsing and causing blurred printing dots due to excessive wetting.

In a further embodiment, the content of the surface tension-adjustment additive in the predicted formula 23 ranges from 0.1 to 3.5 phr (parts per hundreds of resin). According to experimental results, compared to formulas without the addition of surface tension-adjustment additives, the printing resolution of printed products 25 produced using formulas with the addition of 0.1 to 3.5 phr surface tension-adjustment additives can be improved by 10-25%, and color stability (measured with the Color Consistency Index; CCI) can be increased by 15-30%. Furthermore, the average Delta E value of printed products 25 (i.e., the square root of the sum of the squares of the differences in L*, a*, and b* between printed products 25 and the expected color values 22) can be significantly reduced from 6.39 to 3.89. Additionally, the training error of the color-matching model 20 decreases from 0.349 to 0.302, and the testing error decreases from 0.999 to 0.901. This indicates that the addition of surface tension-adjustment additives can further improve the training convergence and color accuracy of the color model 20.

The printing method of the present disclosure, or certain embodiments thereof, may be embodied in the form of program code stored on tangible media such as floppy disks, CDs, hard drives, or any other machine-readable (computer-readable) storage media. When the program code is loaded and executed by a machine such as a computer, the machine becomes a device or system participating in the present invention. The printing method, system, and device of the present invention may also be transmitted in the form of program code via transmission media such as wires or cables, optical fibers, wireless networks, satellite signals, or any other transmission method. When the program code is received, loaded, and executed by a machine such as a computer, handheld device, or wearable device, the machine becomes a device or system participating in the present invention. When implemented in a general-purpose processor, the program code combines with the processor to provide an operation similar to that of application-specific logic circuits in a unique device.

The printing system and printing method with intelligent color-matching provided in the present disclosure promote the intelligence and efficiency of the printing process, effectively reducing the time required for the color-matching process by over 50% and saving ink material by over 25%.

The above paragraphs are described with multiple aspects. Obviously, the teachings of the specification may be performed in multiple ways. Any specific structure or function disclosed in examples is only a representative situation. According to the teachings of the specification, it should be noted by those skilled in the art that any aspect disclosed may be performed individually, or that more than two aspects could be combined and performed.

While the disclosure has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A printing system with intelligent color-matching, comprising:
a storage device, storing a program, a color-matching dataset, and a color-matching model, wherein the color-matching dataset comprises multiple pieces of color-matching data, and each piece of color-matching data includes an ink formula and a corresponding printing color value for the ink formula;
a printing device, controlled to produce a printed product; and
a processing device, connected to the printing device, and configured to load the program from the storage device to perform:
training the color-matching model using the color-matching dataset;
inputting an expected color value into the trained color-matching model, and obtaining a predicted formula output by the trained color-matching model; and
based on the predicted formula, controlling the printing device to produce the printed product.

2. The printing system as claimed in claim 1, wherein the ink formula and the predicted formula are each associated with a composition of multiple chemical materials, and one of the chemical materials is a surface tension-adjusting additive.

3. The printing system as claimed in claim 2, wherein content of the surface tension-adjusting additive in the predicted formula ranges from 0.1 to 3.5 phr (parts per hundreds of resin).

4. The printing system as claimed in claim 2, wherein the surface tension-adjusting additive has a spherical polyester structure, and periphery of the polyester structure has hydroxyl groups, along with multiple alkyl extended chains.

5. The printing system as claimed in claim 1, wherein the color-matching model is selected from a linear regression model, a neural network regression model, a decision tree regression model, and a random forest regression model.

6. A printing method with intelligent color-matching, executed by a processing device, the printing method comprising:
training a color-matching model using a color-matching dataset, wherein the color-matching dataset comprises multiple pieces of color-matching data, and each piece of color-matching data includes an ink formula and a corresponding printing color value for the ink formula;
inputting an expected color value into the trained color-matching model, and obtaining a predicted formula output by the trained color-matching model; and
based on the predicted formula, controlling a printing device to produce a printed product.

7. The printing method as claimed in claim 6, wherein the ink formula and the predicted formula are each associated with a composition of multiple chemical materials, and one of the chemical materials is a surface tension-adjusting additive.

8. The printing method as claimed in claim 7, wherein content of the surface tension-adjusting additive in the predicted formula ranges from 0.1 to 3.5 phr (parts per hundreds of resin).

9. The printing method as claimed in claim 7, wherein the surface tension-adjusting additive has a spherical polyester structure, and periphery of the polyester structure has hydroxyl groups, along with multiple alkyl extended chains.

10. The printing method as claimed in claim 6, wherein the color-matching model is selected from a linear regression model, a neural network regression model, a decision tree regression model, and a random forest regression model.
